(19) United States
(12) Patent Application Publication
(10) Pub. No.: US 2009/0100697 A1
(43) Pub. Date: Apr. 23, 2009

(54) Fluff filter apparatus and domestic appliance containing such a fluff filter apparatus

(75) Inventor: Guenter Steffens, Dallgow-Doeberitz (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeraete GmbH, Muenchen (DE)

(21) Appl. No.: 12/287,344

(22) Filed: Oct. 8, 2008

(30) Foreign Application Priority Data
Oct. 18, 2007 (DE) 10 2007 049 959.2

(51) Int. Cl. F26B 21/00

(52) U.S. Cl. 34/82

(57) ABSTRACT

A fluff filter apparatus for a domestic appliance includes a first fluff filter, and a second fluff filter movably connected to the first fluff filter.

### BACKGROUND OF THE INVENTION

The invention relates to a fluff filter apparatus for a domestic appliance, in particular a tumble dryer or a washer dryer, which has a first fluff filter and at least one second fluff filter. Furthermore, the invention relates to a domestic appliance for the care of items of laundry using such a fluff filter apparatus.

### SUMMARY OF THE INVENTION

Tumble dryers are known in which simply a fluff sieve is used as the fluff filter. In the case of tumble dryers which have a heat pump, a second fluff sieve or a second fluff filter is normally used in order to protect the finely laminated heat exchangers of the heat pump. The two fluff filters are implemented as separate components and positioned at different locations in the domestic appliance. To ensure correct functionality it is necessary for both fluff sieves to be cleaned regularly after a certain period of operation of the domestic appliance.

On account of the place where it is positioned, one fluff sieve is for the most part in the field of view of the user during unloading and loading of the dryer, with the result that on account of the easier accessibility and the facility of recognizing the fluff sieve the user is also made conscious of its cleaning requirement. The other fluff sieve is for the most part accessible only by way of a separate flap which is normally also fitted relatively low on the base unit of the domestic appliance. As a result, the user is not made directly conscious of the need to clean this fluff sieve and this action is frequently forgotten. This leads to impaired functioning of the domestic appliance. Precisely the maintenance of this second fluff sieve is however important because it is for the most part the finer fluff pieces which are deposited in the latter and the airways there become relatively seriously obstructed after repeated operating cycles, with the result that the air flow is restricted. Last but not least, the operating performance of the domestic appliance in respect of its energy consumption and the time requirement for a cleaning program is thus also degraded as a result.

The object of the present invention is to simplify the manageability of a fluff filter apparatus with a plurality of fluff filters and in particular to improve the cleanability.

This object is achieved by a fluff filter apparatus having the features as claimed in claim 1, and a domestic appliance having the features as claimed in claim 6.

A fluff filter apparatus according to the invention for a domestic appliance comprises a first fluff filter and at least one further second fluff filter. The two fluff filters are connected to one another but are nevertheless movable relative to one another. By employing such an embodiment of the fluff filter apparatus it is possible to create a contiguous overall construct which can be mounted at specific locations, and can be removed again from those locations, in the domestic appliance in a simple manner and with a low level of effort on account of the flexible movability. Moreover, the multiple fluff filters are always contiguous and are basically available for cleaning purposes in their complete form. Even in the case of multiple fluff filters, all are thus always cleaned and fluff filters which are located at positions not lying in the field of view in the domestic appliance are nevertheless not forgotten in respect of their cleaning. Not least, the operating performance of the domestic appliance can also be substantially improved as a result.

By preference, the two fluff filters are connected to one another by means of a hinge device. The hinge device can be constructed relatively simply and have a connecting arm, or where applicable also a plurality of such connecting arms, which connecting arm is arranged or mounted in pivoting fashion on a fluff filter. Apart from a space-saving and nevertheless highly flexible connection construction, a concept can as a result be made possible which employs a bare minimum of components and is thus very cost-effective.

By preference, the two fluff filters are arranged spaced apart with respect to one another. Directly as a result of this, the requirements in respect of the local positioning of the relevant fluff filters in the domestic appliance can be taken into account whilst nevertheless retaining the mechanical connection. Their movability relative to one another can also be configured extremely flexibly as a result of this positioning.

By preference, the connection between the two fluff filters is implemented such that the latter can be moved in a translatory and/or rotatory manner relative to one another.

A domestic appliance according to the invention for the care of items of laundry, in particular a tumble dryer or a washer dryer, comprises a fluff filter apparatus according to the invention or an advantageous embodiment thereof.

By preference, the first fluff filter is arranged in a bearing shield of the domestic appliance.

The second fluff filter is preferably arranged upstream of a heat exchanger in the direction of flow of the process air in the domestic appliance. In particular in the situation when the domestic appliance is implemented with a heat pump, this second fluff filter is positioned upstream of the heat pump. The extremely fine fluff pieces can be filtered out by this means and the airways through the heat pump do not become clogged by these finer fluff pieces.

By preference, the entire fluff filter apparatus can be removed by way of a common shaft in the domestic appliance, in particular by way of the bearing shield, and also inserted again by way of this shaft.

### BRIEF DESCRIPTION OF THE DRAWINGS

An embodiment of the invention will be described in detail in the following with reference to schematic drawings. In the drawings:

FIG. 1 shows a vertical sectional representation through a tumble dryer;

FIG. 2 shows a schematic representation of a fluff filter apparatus;

FIG. 3 shows a further sectional representation when viewing the tumble dryer from the front in a first positional state of the fluff filter apparatus;

FIG. 4 shows a representation of the tumble dryer according to FIG. 2 in a second positional state of the fluff filter apparatus;

FIG. 5 shows a representation of the tumble dryer according to FIG. 2 in a third positional state of the fluff filter apparatus; and

FIG. 6 shows a representation of the tumble dryer according to FIG. 2 in a fourth positional state of the fluff filter apparatus.

The same elements or elements having the same function are identified by the same reference characters in all the figures.

### DETAILED DESCRIPTION OF EXEMPLARY EMBODIMENTS OF THE PRESENT INVENTION

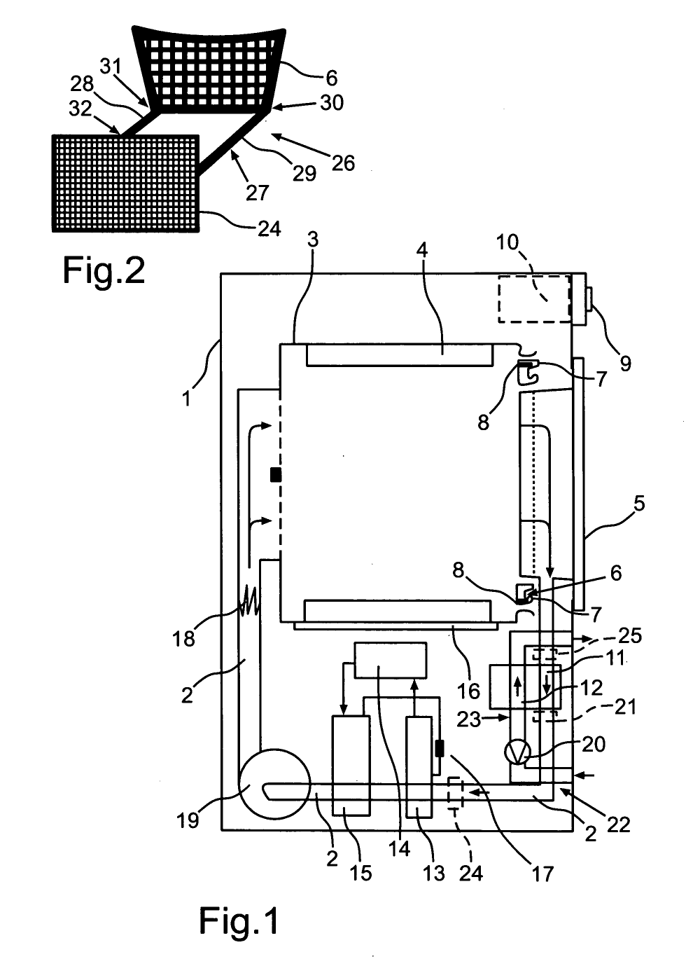

FIG. 1 shows a vertical section through a condensation dryer 1 which is referred to in the following as dryer 1. The dryer 1 illustrated has a drum 3 capable of rotation around a horizontal axis, which is designed as a drying chamber. Paddles 4 are attached inside the drum 3 in order to move the washing during a drum rotation. Process air is passed by means of a first fan 19 by way of a heater 18 through the drum 3, an air-to-air heat exchanger 11, 12 and a heat pump 13, 14, 15 in an air duct 2 in a closed circuit (process air circuit 2). After passing through the drum 3 the moist warm process air is cooled and, after condensation of the moisture contained in the process air, is heated again. In this situation, heated air is introduced into the drum 3 through the latter's perforated base by the heater 18, which can be single-stage or multi-stage, from the rear, in other words from the side of the drum 3 situated opposite a dryer door 5. From there this process air comes into contact with the washing to be dried and flows through the loading opening of the drum 3 to a fluff sieve 6 inside the dryer door 5 closing the loading opening. The air flow is subsequently deflected downward in the dryer door 5 and conveyed by the air duct 2 to the air-to-air heat exchanger 11, 12. As a result of the cooling, the moisture taken up by the process air from the items of laundry condenses there and is collected in a condensate container 21 drawn in a dashed line in FIG. 1, from where it can disposed of.

The somewhat cooled process air is then passed to an evaporator 13 of the heat pump 13, 14, 15, where it is cooled further. The cooling agent of this heat pump 13, 14, 15 evaporated in this situation in the evaporator 13 is conveyed by way of a compressor 14 to a condenser 15. In the condenser 15 the cooling agent liquefies whilst dissipating heat to the process air. The cooling agent now present in liquid form is then conveyed to a throttle valve 17 and passed on again by way of this throttle valve 17 to the evaporator 13, as a result of which the cooling agent circuit is completed. The cooling air is taken from the room air and, after passing through the air-to-air heat exchanger 11, 12, is returned to the room air again. The air circulation through the air-to-air heat exchanger 11, 12 is generated by a second fan 20.

In the embodiment shown in FIG. 1 the drum 3 is pivoted at the rear base by means of a swivel bearing and at the front by means of a bearing shield 7, whereby the drum 3 with a flange is supported on a sliding strip 8 on the bearing shield 7 and is thus held at the front end. Control of the condensation dryer is exercised by way of a control facility 10 which can be regulated by the user by way of an operating unit 9.

Furthermore, FIG. 1 also illustrates that the drum 3 at least in its lower area is mounted on rollers 16 which are associated with a roller bearing.

The second fan 20 is arranged such that a cooling air flow generated by the fan 20 can be used both for the air-to-air heat exchanger 11, 12 and also for the compressor 14 and thus provides for cooling of the air-to-air heat exchanger 11, 12 and also of the compressor 14.

To this end, an inlet tract 22 and also an exhaust tract, or outlet tract, 23 is associated with the second fan 20.

In addition to the first fluff sieve or fluff filter 6 implemented in the bearing shield 7, the dryer 1 comprises at least a second fluff sieve or a second fluff filter 24. The latter is arranged upstream of the heat pump 13, 14, 15 in the direction of flow of the process air.

Furthermore, the dryer 1 can comprise a further fluff sieve or a further fluff filter 25 which is arranged upstream of the air-to-air heat exchanger 11, 12 in the direction of flow of the process air.

The fluff filter 6 and the fluff filter 24 are associated with a fluff filter apparatus 26 (FIG. 2).

The dryer 1 can also be designed as a vented dryer. Similarly, provision can be made for the components 11, 12, 20, 22, 23 not to be installed in the dryer 1.

By way of further explanation of the fluff filter apparatus 26 shown in FIG. 2 the fluff filters 6 and 24 are by way of example associated with this fluff filter apparatus 26.

These at least two fluff filters 6 and 24 are connected to one another in the exemplary embodiment by way of a hinge device 27, whereby the connection is implemented in such a manner that these two fluff filters 6 and 24 are also movable relative to one another. In the exemplary embodiment the hinge device 27 comprises two linking rods 28 and 29 which are connected with the fluff filters 6 and 24 in movable fashion using pivotal points 30, 31, 32 and 33. Through this embodiment, the fluff filters 6 and 24 can be moved in both a translatory and also a rotatory manner relative to one another.

Furthermore, the fluff filters 6 and 24 are arranged spaced apart with respect to one another by means of this hinge device 27.

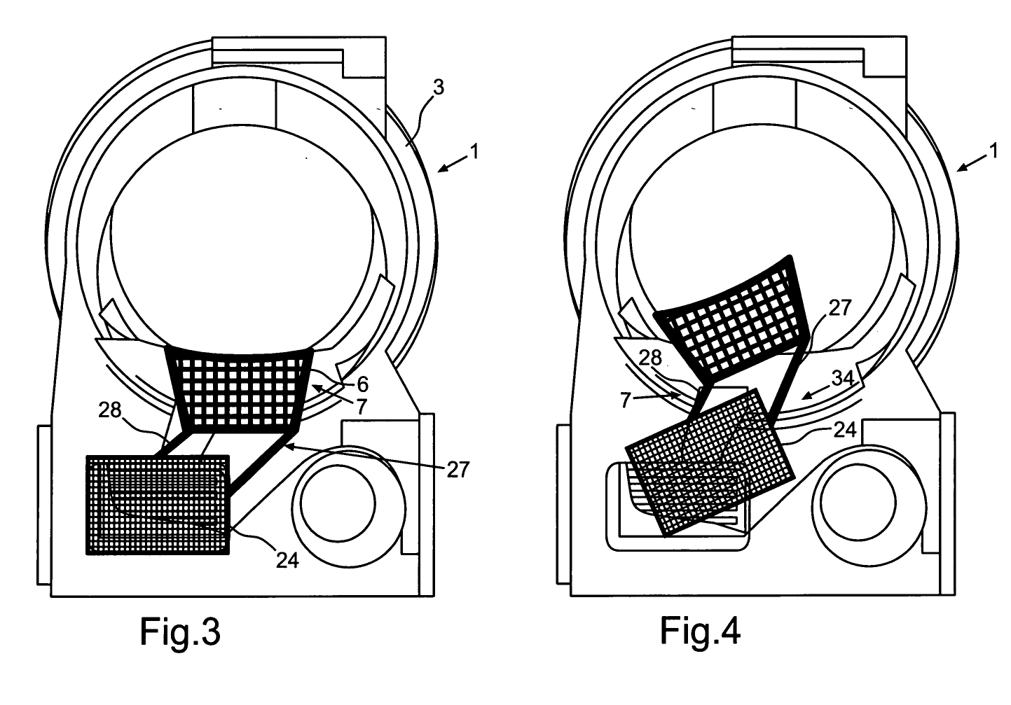

In contrast to the representation according to FIG. 1, FIG. 3 does not show a sectional representation according to a view from the side of the dryer 1, but it shows a sectional representation with a view from the front. FIG. 3 shows a positional state of the fluff filter apparatus 26 when fully inserted into the dryer 1. The fluff filter apparatus 26 is introduced into a shaft 34 common to the fluff filters 6 and 24 and brought into the final position shown in FIG. 3.

FIG. 4 shows a sectional representation corresponding to FIG. 3, whereby a partial removal position of the fluff filter apparatus 26 is already illustrated in this regard. Based on the inserted final position according to the representation in FIG. 3, the fluff filter apparatus 26 has here already been partially raised upward above the common shaft 34. Use of the hinge device 27 means that it is also possible to effect a vertical removal, not in a straight line, in the upward direction because it is possible to tilt the fluff sieves or fluff filters 6 and 24 relative to one another and a simple removal is possible even in the case of a curved shaft 34 or a removal path which is not in a straight line.

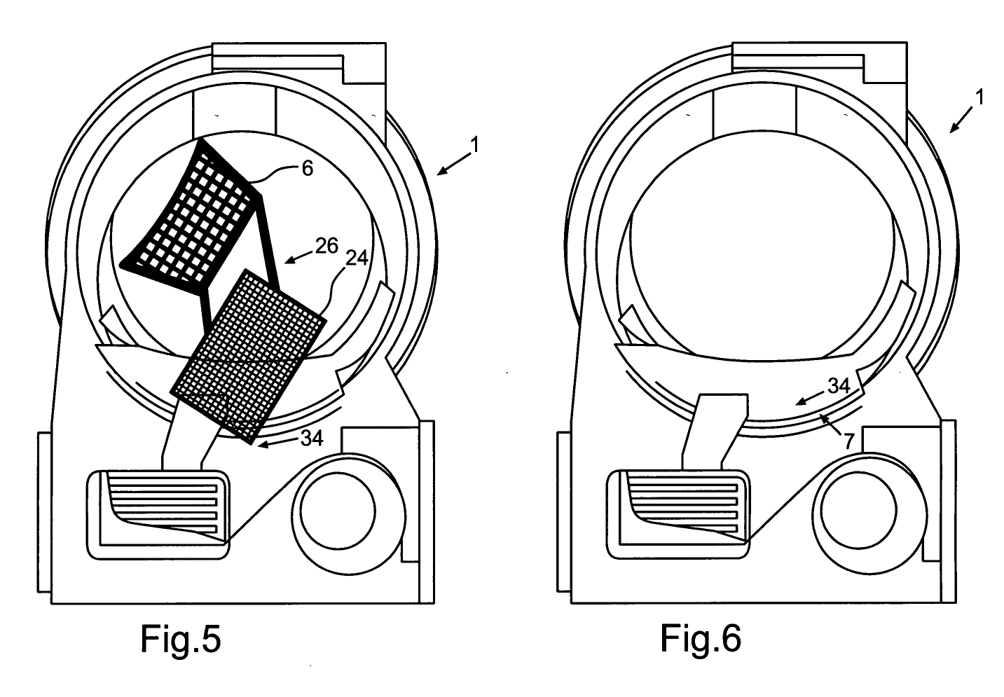

FIG. 5 then shows a further intermediate state with regard to the removal of the fluff filter apparatus 26, whereby in this regard the first fluff filter 6 has already been completely removed from the shaft 34 and thus also from the bearing shield 7.

FIG. 6 then shows the completely removed state of the fluff filter apparatus 26 which is no longer illustrated in FIG. 6. Based on the illustration according to FIG. 6, the entire fluff filter apparatus 26 can then also be re-inserted or re-introduced again in a simple manner after cleaning of the fluff filters 6 and 24 until the final state according to FIG. 3 has been achieved again.

1. A fluff filter apparatus for a domestic appliance, comprising:
a first fluff filter; and
a second fluff filter movably connected to the first fluff filter.

2. The fluff filter apparatus of claim 1, further comprising a hinge connecting the second fluff filter to the first fluff filter.

3. The fluff filter apparatus of claim 2, wherein the hinge comprises a connecting arm pivotally mounted on the fluff filters.

4. The fluff filter of claim 1, wherein the fluff filters are spaced apart from one another.

5. The fluff filter apparatus of claim 1, wherein the fluff filters can be moved in a translatory and/or rotary manner relative to one another.

6. A domestic appliance for the care of items of laundry that comprises:
a first fluff filter; and
a second fluff filter movably connected to the first fluff filter.

7. The domestic appliance of claim 6, wherein the first fluff filter is in a bearing shield.

8. The domestic appliance of claim 6, wherein the second fluff filter is upstream of a heat exchanger in a direction of flow of a process air.

9. The domestic appliance of claim 6, further comprising a common shaft through which the first fluff filter and the second fluff filter may be removed and inserted from the domestic appliance.

10. The domestic appliance of claim 9, wherein the common shaft comprises a bearing shield.
